(19) United States
(12) Patent Application Publication
(10) Pub. No.: US 2026/0159407 A1
(43) Pub. Date: Jun. 11, 2026

(54) PROCESS FOR LIQUID-LIQUID EXTRACTION OF RARE EARTHS OR ACTINIDES VIA SYNERGISTIC COMBINATION OF A CO-SOLVENT HYDROTROPE WITH ANIONIC OR CHELATING EXTRACTANTS

(71) Applicants: COMMISSARIAT A L'ENERGIE ATOMIQUE ET AUX ENERGIES ALTERNATIVES, PARIS (FR); CENTRE NATIONAL DE LA RECHERCHE SCIENTIFIQUE, PARIS (FR); UNIVERSITE DE MONTPELLIER, MONTPELLIER (FR); ECOLE NATIONALE SUPERIEURE DE CHIMIE DE MONTPELLIER, MONTPELLIER (FR)

(72) Inventors: Thomas ZEMB, Bagnols-sur-Cèze (FR); Asmae EL MAANGAR, Bagnols-sur-Cèze (FR); Jean DUHAMET, Bagnols-sur-Cèze (FR); Stéphane PELLET-ROSTAING, Bagnols-sur-Cèze Cedex (FR)

(73) Assignees: COMMISSARIAT A L'ENERGIE ATOMIQUE ET AUX ENERGIES ALTERNATIVES, PARIS (FR); CENTRE NATIONAL DE LA RECHERCHE SCIENTIFIQUE, PARIS (FR); UNIVERSITE DE MONTPELLIER, MONTPELLIER (FR); ECOLE NATIONALE SUPERIEURE DE CHIMIE DE MONTPELLIER, MONTPELLIER (FR)

(21) Appl. No.: 18/707,734

(22) PCT Filed: Nov. 3, 2022
(86) PCT No.: PCT/EP2022/080663

§ 371 Date: May 6, 2024

(30) Foreign Application Priority Data
Nov. 4, 2021 (FR) 2111746

(51) Int. Cl. C01F 17/17; C01G 43/00; C22B 3/26; C22B 3/38; C22B 3/40; C22B 59/00; C22B 60/02

(52) U.S. Cl. CPC C01F 17/17; C01G 43/003; C22B 3/26; C22B 3/3846; C22B 3/402; C22B 59/00; C22B 60/026

(57) ABSTRACT

A process for liquid-liquid extraction of at least one salt of a metal selected from elements from the rare earths group and from the actinides group from an acidic aqueous phase containing them. The process includes, in particular, a step of mixing an acidic aqueous phase including the salt of the metal and at least one non-ionic hydrotrope with an organic phase having at least one non-ionic hydrotrope and at least one extractant.

### FIELD

The present invention relates to the field of extraction and purification of elements of the rare earths or actinides group from acidic aqueous solutions in which they are found. The process in accordance with the invention is particularly adapted to the extraction of uranium (U), lanthanum (La), neodymium (Nd), europium (Eu), dysprosium (Dy), erbium (Er), ytterbium (Yb), or a mixture thereof.

### BACKGROUND

Modern metallurgy mainly covers hydrometallurgical, pyrometallurgical, electrometallurgical and nuclear approaches. The hydrometallurgical approach is the dominant reference technology for the extraction and purification of elements of the rare earths group and the actinides group.

With the exception of natural deposits of gold, silver, copper and platinum, metals found in nature mainly appear in the form of salts and minerals as a result of natural reaction processes with the surrounding chemical elements. Generally, the desired metal is extracted from minerals or ores. The best-known ore containing uranium is uraninite, formerly known as pitchblende. Rare earth elements are found in various minerals such as bastnaesite, monazite, xenotime, loparite and apatite. The mining process is followed by mechanical and chemical separation, enrichment and purification steps. The raw materials obtained, such as rare earth oxides of sufficient purity or uranium concentrate (also known as “yellowcake”) for nuclear fuels, are then used to create products. Rare earth elements are essential compounds for modern consumer electronics and are also used as magnetic compounds in wind turbine generators or motors for electric mobility. These metals are therefore essential for a wide range of modern inventions, vital to the development of efficient, carbon-free and environmentally friendly technologies. They are an important ingredient in modern hydride batteries, hybrid and electric cars, smartphones, HD screens, laser technology, crude oil refining, catalysis, as well as for permanent magnets as magnetic compounds in generators.

Actinides are a family of 15 chemical elements on the periodic table, from actinium (No. 89) to lawrencium (No. 103). These heavy metals take their name from actinium, the first of the family, because of their related chemical properties. They are all f-block elements, with the exception of lawrencium, which belongs to the d-block. All actinides are radioactive, releasing energy through radioactive decay. They are all fissile into fast neutrons, and some into thermal neutrons. Uranium, thorium and plutonium are the most abundant actinides on Earth. Unlike lanthanides, which occur in nature in appreciable amounts (with the exception of promethium), most actinides are very rare elements. The most abundant natural elements are thorium and uranium; and the easiest to synthesise is plutonium. The others are only found in traces.

Consequently, the accessibility of rare earths and actinides is of vital importance to the development and proliferation of carbon dioxide-free technologies. Nuclear power plants make it possible to produce energy without emitting carbon dioxide. The aim of the Energy Transition Act adopted by the French government in 2015 is to achieve a more diversified, low-carbon electricity generation mix. By 2030, a total share of nuclear power of around 50% is planned. Nuclear power and the nuclear fuel cycle will therefore continue to play an important role in French energy policy.

Furthermore, the lifespan of any product is limited. For electronic apparatuses containing rare earth elements, such as smartphones, the lifespan is generally estimated at two or three years, while magnets containing rare earths can be used for around 15 years. The residence time of a nuclear fuel rod depends on the type of reactor and the fuel used, but the fuel generally remains in the reactor for four to six years. When the end-of-life state of a metal-containing product is reached, recycling strategies are important to reduce the amount of waste created and increase the amount of reusable material. For nuclear fuels and rare earth elements, there are various recycling and waste management strategies.

Any recycling strategy must be effective, inexpensive and applicable on an industrial scale. Furthermore, ecological, sustainable and green chemistry aspects must be taken into account throughout the life cycle of metals.

One of the oldest and now considered ‘mature’ separation procedures is liquid-liquid extraction, also known as solvent extraction. This procedure is generally applied between the extraction and production of raw materials, and after the end-of-life of products to recover raw materials and sort waste. In the field of nuclear fuel cycle management, liquid-liquid extraction is used to separate and isolate radioactive fission products (especially the PUREX and DIAMEX processes in France). By way of example, the PUREX (Plutonium, Uranium, Reduction, EXtraction) chemical process is a method for treating spent nuclear fuel, used since 1947 to separate plutonium and uranium independently from minor actinides and fission products by a liquid-liquid extraction method, wherein uranium and plutonium are extracted using an organic solvent comprised of 30% tributyl phosphate (TBP) in dodecane. The fission products are then recovered in a nitric acid phase and then plutonium is extracted from the uranium/plutonium solution by plutonium reduction.

These processes make it possible to separate uranium and plutonium from fission products (e.g. caesium) and transuranics (americium, curium, etc.). Although previously considered as waste, these transuranics can be used again in a closed fuel cycle for 4th generation generators. Furthermore, liquid-liquid extraction enables rare earth elements to be selectively separated from raw ores and Waste from Electrical and Electronic Equipment (WEEE).

Hydrometallurgical liquid-liquid extraction is defined by the IUPAC (International Union of Pure and Applied Chemistry) as the process of transferring a dissolved substance from one liquid phase to another (immiscible or partially miscible) one in contact therewith. The distribution of solute species between the two phases (distribution coefficient) makes it possible to estimate efficiency of a given extraction method. If more than one compound is dissolved and can be extracted, the selectivity of the approach chosen is important to obtain the desired results.

The ultimate goal of a liquid-liquid extraction process is to selectively transfer (desired) ions from phase A to phase B, while undesired ions remain in phase A. De-extraction is the reverse step. Successive extraction and de-extraction cycles, with controlled temperature and pH, form the basis of any separation of rare earths or actinides from other metals present, such as iron for example.

The term ‘hydrometallurgy’ describes the recovery of metals from ores, concentrates and recycled or residual materials. In both the mining and recycling sectors, main steps are leaching, concentration and recovery. In the context of hydrometallurgy, phase A represents in most cases an acidic aqueous phase loaded with desired and undesired ions. This phase is also called “feed solution” and results from the treatment of ores and minerals or—in the case of recycling—valuable waste, for example electronic and metal waste or used nuclear fuel rods, with acid. This wet chemical process is called “leaching” and is the first step in the extraction cycle.

In a second, so-called concentration, step, the feed solution is brought into contact with a formulated organic phase. It is designed to extract the desired ions into the organic phase, which is the field of liquid-liquid extraction using ternary or quaternary formulations. In all the processes currently known and used, the organic phase contains one or more complexing extractants, either pure or diluted in a diluent, and often a phase modifier.

After loading the organic phase with the desired metals, the third step is “de-extraction”, during which said metals are re-extracted from the organic phase—the “extract”—into a fresh aqueous phase. The organic solvent is recovered and can be reused for another extraction cycle.

The success of any liquid-liquid extraction process depends on the distribution of a compound between the two phases. This distribution, according to the IUPAC convention for aqueous/organic systems, is described by the distribution ratio (D_{A}) on a molar concentration scale. It is defined as “the total analytical concentration of an element in the organic phase relative to its total analytical concentration in the aqueous phase, generally measured at equilibrium”. This distribution ratio D_{A} corresponds to the ratio of the molar concentration of a solute species A in the organic phase ([A]_{org}) to the molar concentration of the same solute species A in the aqueous phase ([A]_{aq}).

The higher D_{A}, the more solute A is in the organic phase, and the more efficient the extraction. In the case where more than one solute (species A and B) is extracted, selectivity of the solvent extraction system is then described by the separation factor(S) according to the following equation (1):

$$\begin{matrix}[ Equation 1 ] & \\ {S}_{A / B} = {D}_{A} / {D}_{B} = {[ A ]}_{org} \cdot {[ B ]}_{aq} {/ [ A ]}_{aq} \cdot {[ B ]}_{org} & ( 1 )\end{matrix}$$

wherein:
D_{A} and D_{B} are the distribution ratios for the two species A and B, respectively. The greater the difference between the two distribution ratios D_{A} and D_{B}, the more selective the liquid-liquid extraction process is towards the species with the higher D.

One of the main obstacles to recycling rare earths is the fact that the amount of rare earths used in most products ranges from one milligramme to several kilogrammes. This, combined with the complexity of their applications, the difficulty of separating the different elements from each other to obtain pure and unique elements due to their similar properties, means that less than 1% of rare earths is currently recycled. Liquid-liquid extraction is a possible way forward, as some of the processes for extracting lanthanoid cations have already been applied on an industrial scale.

The main liquid-liquid extraction processes used in industry differ especially in the type of solvents implemented and in the extraction and washing methods used. The solvents implemented in these processes make it possible to extract various rare earths with a purity generally greater than 99.9%. Commercially, the most commonly used solvents are organophosphorus extractants such as phosphoric acids, phosphonic acids and phosphinic acids; carboxylic acids and alkyl phosphates. These are for example di-2-ethylhexylphosphoric acid (HDEHP), 2-ethylhexylphosphonic acid (HEHEHP), bis(trimethyl-2,2,4-pentyl)phosphinic acid (such as the product sold under the trade name Cyanex® 272), mixtures of branched carboxylic acids such as the products sold under the trade names Versatic™ Acid 10 and Versatic™ Acid 911, tri-n-butyl phosphate (TBP) or Aliquat 336.

Tributyl phosphate (TBP) has long been the solvent most commonly used by major industrial groups in extraction processes. Quaternary ammoniums as well as tertiary carboxylic acids (versatic acids) are also used commercially.

Despite the use of these formulations, which are often diluted in petroleum fractions (Isopar®, Isane®, Kerosene, etc.) in well-established and efficient processes for the production and purification of rare earths, some problems associated with their use are of concern to scientists and technologists.

The separation of trivalent actinoid cations (An³⁺) from an aqueous solution of nitrate salts also containing dissolved trivalent lanthanoid species (Ln³⁺) is challenging. The difficulties in separating trivalent actinoid and lanthanoid cations arise from the similarity of ionic radii and hydration numbers. Therefore, in a first step, Ln³⁺/An³⁺ co-extraction is carried out with the PUREX raffinate at a very high nitric acid concentration. This process, known as DIAMEX (DIAMide EXtraction), uses malonamide-based extractants such as N,N′-dimethyl,N,N′-dioctylhexylethoxymalonamide (DMDOHEMA). In a second step, lanthanoid and actinoid cations are separated using the SANEX (Separation of ActiNoides by EXtraction) extraction process under less acidic conditions. The minor actinoid cations Am³⁺ and Cm³⁺ are finally separated by another process similar to DIAMEX.

N,N-dialkylamides (or equivalently, monoamide extractants) have proved to be a promising group of extractants for actinide extraction. They have good affinities for hexavalent and tetravalent actinide ions and low affinities for the main fission products. This group of extractants is sparingly soluble in aqueous solution and stable against chemical degradation and radiolysis. Synthesis and purification are fairly straightforward, and physicochemical properties and selectivities can be easily adjusted by varying the three hydrocarbon chains. The main advantage of N,N-dialkylamides is the possibility of simultaneous extraction of uranium and plutonium without the need for a redox step and additional reducing agents as is the case with TBP. The separation of uranium and plutonium can be achieved by adjusting pH of the aqueous solution.

However, it has been observed and modelled that increasing the concentration of uranium in the organic phase, comprised of monoamide diluted in an aliphatic diluent, leads to an increase in viscosity that may be prohibitive for industrial use in conventional extractors (M. Pleines, “Viscosity-control and prediction of microemulsions. University of Montpellier Thesis,” PhD Thesis, 2018). Thus, if solvation of these compounds is poor, the organic phase in equilibrium with the aqueous phase separates into two distinct phases. This is the so-called “3rd phase” phenomenon.

Whatever the nature of the formulations studied, the formation of the “3rd phase” is the major obstacle in the use of known solvents, because in all industrial systems, the 3rd phase is a stable, viscous emulsion which stops the liquid-liquid extraction, requiring complete emptying and cleaning of the containers, which is extremely costly in the case of rare earths and in practice impossible in the case of extraction containing radioactive elements. The risk of a third phase appearing is an element that limits process intensification, and therefore cost. The rare theoretical models of third phase appearance published (C. Erlinger et al., “Attractive Interactions between Reverse Aggregates and Phase Separation in Concentrated Malonamide Extractant Solutions”, Langmuir, vol. 15, no. 7, pp. 2290-230 March 1999, doi: 10.1021/la980313w) are not yet predictive enough to serve as a guide, and the third phase is avoided in practice by conducting systematic trial-and-error test runs in pilot or pre-pilot plants. This leads operators to proceed under conditions where the concentration of acid and metal are below the LOC (Limiting Organic Concentration), which in practice limits loading capacity of conventional commercial solvents to values below 100 g·L⁻¹. To achieve this maximum loading capacity, several methods are used to increase LOC, such as increasing the temperature and polarity of the diluent or using a phase modifier in the solvent, such as fatty alcohols, monoamides such as DHOA in the TODGA-dodecane system, or phosphates such as TBP used in the CMPO-dodecane system of the TRUEX actinide (III)/lanthanide (III) co-extraction process, in all cases with unfavourable consequences for extraction in terms of efficiency and selectivity.

There is therefore a need for a process for selectively extracting one or more elements belonging to the rare earths group or the actinides group in a high-performance, low-cost and environmentally-friendly way, while avoiding this 3rd phase phenomenon.

### SUMMARY

It is therefore in order to meet this need that the inventors have developed the extraction process which is the subject matter of the present invention.

Very surprisingly, and according to a line of reasoning which goes completely against teachings of the state of the art, the inventors discovered that by replacing all or some of the branched alkane type diluents usually used in liquid-liquid extraction with a non-ionic hydrotropic agent, the 3rd phase phenomenon could be completely avoided.

More precisely, the invention is concerned with an extraction process designed for the recovery of one or more elements belonging to the rare earths group or the actinides group, wherein a non-ionic hydrotropic agent (co-solvent) combined with a solvating or ionic (cationic or anionic) extractant is used as a novel extraction system. Said novel extraction system replaces the organic phase conventionally used in liquid-liquid extraction processes, which comprises an extractant molecule, an often aliphatic diluent and a phase modifier.

The object of the present invention is therefore a process for liquid-liquid extraction of at least one salt of a metal selected from elements of the rare earths group and the actinides group from an acidic aqueous phase containing them, said process being characterised in that it comprises at least the following steps of:
(i) preparing a balanced acidic aqueous phase (Ph_{aq.e}) comprising said at least one salt of said metal and at least one non-ionic hydrotropic agent in an initial amount Q1,
(ii) preparing an organic phase (Ph_{org}) comprising at least one non-ionic hydrotropic agent in an initial amount Q2 and at least one extractant, (iii) bringing said organic phase prepared above in step (ii) into contact with said balanced acidic aqueous phase prepared above in step (i), to obtain a mixture M,
(iv) stirring said mixture M, and then
(v) separating said organic phase from the balanced acidic aqueous phase.

By virtue of the liquid-liquid extraction process in accordance with the present invention, it is possible to extract metals from the rare earths group and the actinides group from an acidic aqueous phase efficiently and selectively, while reducing the increase in viscosity when said metals pass into the organic phase and reducing or eliminating the so-called “3rd phase” effect usually observed when implementing extraction processes using conventional solvents such as hydrocarbons. In particular, the extraction process in accordance with the present invention makes it possible to extract from an acidic solution at least one rare earth and/or actinide likely to be present in the acidic solution, with high extraction yields and high selectivity with respect to metal impurities likely to be also present in said acidic solution and, especially, with respect to iron. One of the advantages of the process in accordance with the invention is also that it can be implemented in an extraction device comprising several stages (typically from 2 to 10 stages) operating in countercurrent according to techniques well known to those skilled in the art. The liquid-liquid extraction process in accordance with the invention can furthermore be carried out in a closed circuit, thereby minimising effluents and drastically reducing costs. Finally, the process in accordance with the invention is easily adaptable to any liquid-liquid extraction process and any extraction facility existing in industry.

### BRIEF DESCRIPTION OF THE DRAWINGS

Other features and advantages of the invention will be apparent from the detailed description of the following examples, thus from the appended figures, in which:

FIG. 1 illustrates influence of the nature of the acid in the aqueous phase on the extraction of europium (Eu) of this acidic aqueous phase at two different acid concentrations: (a): 1 M and (b): 0.03 M;

FIG. 2 shows the course of the selectivity coefficients of the rare earths (La, Nd, Eu, Dy, Er, Yb) with respect to iron, noted Sin/Fe as a function of the nature of the acid. (a): Nitric acid, (b): Phosphoric acid, (c): Sulphuric acid and (d): Hydrochloric acid;

FIG. 3 shows the variation in europium extraction yield as a function of time;

FIG. 4 illustrates influence of PnP on the relative viscosity of the organic phase after extraction;

FIG. 5 shows the loading capacity of the organic phase containing the hydrotrope compared with conventional extraction systems;

FIG. 6 illustrates influence of the acid concentration in the aqueous phase and the extractant concentration in the organic phase on the extraction of europium;

FIG. 7 illustrates influence of the nature of the acid in the aqueous phase on the extraction of europium (Eu) from this acidic aqueous phase at two different acid concentrations: FIG. 1 (a): 0.3 M and FIG. 1 (b): 1 M;

FIG. 8 shows the loading capacity of the organic phase containing the hydrotrope compared with an organic phase containing n-dodecane;

FIG. 9 shows the variation in europium extraction yield as a function of time.

FIG. 10 shows influence of the use of PnP on the synergy;

FIG. 11 shows the course of the distribution coefficients noted D_{Ln,eq}, as a function of the molar fraction of the DMDOHEMA extractant, noted x_{DMDOHEMA};

FIG. 12 shows the course of Europium distribution coefficients as a function of the nature of the hydrotrope used;

FIG. 13 shows the europium distribution coefficients as a function of the acidity of the aqueous phase with two different extractants. (a): HDEHP and (b): DMDOHEMA;

FIG. 14 shows the course of rare earth distribution coefficients as a function of the acidity of the aqueous phase for two different extractants. (a): HDEHP and (b): DMDOHEMA;

FIG. 15 shows the course of the uranium distribution coefficient as a function of the concentration of the extractant DEHiBA;

FIG. 16 shows the course of the uranium distribution coefficient as a function of the concentration of the extractant TOA; and

FIG. 17 schematically represents one exemplary implementation of the recovery process according to the invention designed for the extraction, on an industrial scale, of rare earths and uranium from an acidic aqueous phase.

### DETAILED DESCRIPTION

The invention finds particular application in the purification of uranium prior to the manufacture of fuel elements, in the treatment of irradiated nuclear fuels or in the extraction of uranium from phosphates from mining concentrates.

The invention also finds application in the production of rare earths, whether from concentrates of natural ores rich in rare earths, such as monazites, bastnaesites or xenotimes, or from concentrates resulting from the treatment of natural ores other than ores rich in rare earths, such as concentrates from “urban mines”, i.e. “mines” made up of industrial and domestic post-consumer waste containing rare earths and, especially, waste from electrical and electronic equipment (also known as “WEEE” or “W3E”), or concentrates of scrap from the manufacture of products containing rare earths, as well as in the treatment of aqueous solutions resulting from leaching in order to recover rare earths present in these aqueous solutions.

The rare earths group includes scandium (Sc), yttrium (Y) and the 15 lanthanide elements, namely cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), terbium (Tb), thulium (Tm) and ytterbium (Yb).

The actinides group includes 15 chemical elements from actinium (n°89-Ac) to lawrencium (n°103-Lr), and in particular uranium (n°92-U).

The process in accordance with the present invention is particularly adapted to the extraction of metals selected from the so-called “light” rare earths, such as lanthanum (La) and neodymium (Nd), the so-called “heavy” rare earths, such as europium (Eu), dysprosium (Dy), erbium (Er) and ytterbium (Yb), or even uranium, and mixtures thereof.

According to the invention, by “hydrotropic agent”, it is meant a compound which is soluble both in an aqueous phase and in an organic phase. More precisely, a hydrotropic agent is a compound that solubilises hydrophobic compounds in aqueous solutions. Hydrotropes are typically made up of a hydrophilic part and a hydrophobic part (like surfactants), but the latter is generally too short to cause spontaneous self-aggregation and micelle formation (J. Mehringer, Werner Kunz, 2021, Advances in Colloid and Interface Science 294, 102476). There are acidic, basic or salt electrolyte hydrotropic agents and non-electrolyte hydrotropic agents. Their molecular volume is greater than 0.090 nm³ and less than 0.5 nm³.

The non-ionic hydrotropic agent may especially be selected from short- or medium-chain primary, secondary or tertiary alcohols, as well as from alkylene glycol alkyl ethers. For the purposes of the invention, a “short chain” is a carbon chain having from 1 to 4 carbon atoms and a “medium chain” is a carbon chain having 5 or 6 carbon atoms.

According to one particular embodiment of the invention, the non-ionic hydrotropic agents used in steps (i) and (ii) are selected from:
alkylene glycol alkyl ethers, the alkyl being selected from methyl, ethyl, n-propyl, isopropyl, n-butyl, isobutyl, terbutyl and pentyl and the alkylene being selected from ethylene and propylene and dipropylene; and
primary alcohols including a C₂-C₃ alkyloxy group.

Among such hydrotropic agents, mention can be especially made of 1-propoxy-2-propanol (PnP), dipropylene glycol n-propyl ether (DPnP) and ethylene glycol monopentyl ether (C₅E₁). Of these, 1-propoxy-2-propanol is particularly preferred.

According to one particularly preferred embodiment of the invention, the non-ionic hydrotropic agent present in the balanced acidic aqueous phase is identical to the non-ionic hydrotropic agent present in the organic phase.

By “acidic aqueous phase”, it is meant a solution of an organic or inorganic acid, said acid being referred to as a “strong” or “weak” acid.

The acidic aqueous phase can especially be an acidic solution of a concentrate of a natural or urban ore comprising salts of said metals.

The acid present in the acidic aqueous phase used according to the different steps of the process in accordance with the invention may especially be selected from strong acids such as nitric acid, phosphoric acid, sulphuric acid, hydrochloric acid, and mixtures thereof, weak acids such as acetic acid, formic acid, citric acid and tartaric acid, and mixtures thereof, and from mixtures of at least one strong acid and at least one weak acid.

According to one particular embodiment of the invention, the balanced aqueous acid phase comprises at least one strong acid in a concentration ranging from 1·10⁻⁴ to 6 mol/L, and preferably from about 0.01 to 4 mol/L.

According to one particular embodiment, and when the acid present in the acidic aqueous phase is a strong acid, such as nitric acid for example, and then the acid concentration preferably ranges from 0.01 to 3 mol/L.

According to another particular embodiment of the invention, the acidic aqueous phase comprises at least one weak acid, such as acetic acid for example, in a concentration ranging from 1 to 6 mol/L, and preferably from 1 to 3 mol/L about.

The concentration of metal salt in the acidic aqueous phase is preferably between about 0.01 mol/L and 1.0 mol/L inclusive.

According to the extraction process in accordance with this invention, step (i) is a pre-balancing step of adding to an acidic aqueous solution containing at least one salt of a metal selected from elements of the rare earths group and the actinides group, a pre-balancing phase comprising at least one hydrotropic agent in an initial amount Q1, in order to obtain an balanced acidic aqueous phase (Ph_{aq.e}).

The pre-balancing step enables said acidic aqueous phase to be saturated by said pre-balancing phase and therefore enables the aqueous and organic phases to remain stable during extraction (steps (iii) and (iv)).

According to a particularly preferred embodiment of the invention, the pre-balancing phase is pure 1-propoxy-2-propanol (PnP) or pure dipropylene glycol n-propyl ether (DPnP) or pure ethylene glycol monopentyl ether (C₅E₁). In this case, the initial amount Q1 of hydrotropic agent corresponds to the volume of pure hydrotropic agent used to saturate the acidic aqueous phase.

Preferably, step (i) is carried out by respecting a pre-balancing phase/acidic aqueous phase volume ratio of about 1:1 to 1:10 and even more preferably of about 1:3.

The duration of step (i) generally ranges from 5 to 60 minutes, preferably from 5 to 20 minutes, and even more preferably this duration is about 10 minutes. A duration of 10 minutes makes it possible to achieve saturation of the aqueous phase with said pre-balancing phase.

Step (i) is generally carried out at a temperature ranging from about 20 to 50° C. Preferably, step (i) is carried out at ambient temperature, i.e. at a temperature of about 20° C. to 25° C.

Step (i) is preferably carried out at a pressure at least equal to atmospheric pressure, and even more preferably at atmospheric pressure.

According to one particular embodiment, the process according to the invention may further comprise, prior to step (i), at least one preliminary leaching step. This preliminary leaching step can be carried out in a conventional manner, for example by bringing a solid material comprising the rare earths and/or actinides to be extracted into contact with a solution comprising high concentrations of a strong acid such as sulphuric acid, hydrochloric acid or most often nitric acid, or a weak acid such as acetic acid. This leaching step makes it possible to obtain a solution of elements selected from the rare earths group and the actinides group.

According to the invention, the organic phase comprises at least one non-ionic hydrotropic agent in an initial amount Q2 and at least one extractant. This organic phase generally has a density different by at least 0.1 mg/L from the density of the acidic aqueous phase, which makes it easy to separate the aqueous and organic phases during step (v).

The extractant present in the organic phase prepared in step (ii) can be selected from charged or neutral molecules which are specific for at least one of the elements to be extracted from the balanced acidic aqueous phase and mixtures of these molecules. The extractant may in particular be selected from phosphorus-based non-ionic extractants, amides, carboxylates and some bi-functional molecules. According to one preferred embodiment, the extractant is selected from bis(2-ethylhexyl) phosphoric acid (HDEHP), N,N′-dimethyl-N, N′-dioctylhexyl-ethoxy-malonamide (DMDOHEMA), N,N-di-(2-ethylhexyl) isobutyramide (DEHiBA), trioctylamine (TOA), and mixtures thereof.

According to one particular embodiment of the process according to the invention, the metal to be extracted from the balanced acidic aqueous phase is a lanthanide and the extractant is selected from HDEHP, DMDOHEMA, and mixtures thereof.

According to one particularly advantageous embodiment of the process in accordance with the invention, and when the metal to be extracted from the balanced acidic aqueous phase is a lanthanide, then the extractant is a mixture of HDEHP and DMDOHEMA. Indeed, as is demonstrated in the examples below, the extraction yields of lanthanides which are obtained with an extractant consisting of such a mixture are greater than the sum of the extraction yields which are obtained with an extractant solely consisting of HDEHP or solely of DMDOHEMA, which indicates a synergistic effect of the mixture of HDEHP and DMDOHEMA on the rare earth extraction yield according to the process in accordance with the invention.

When the extractant is a mixture of HDEHP and DMDOHEMA, the molar fraction of DMDOHEMA within the DMDOHEMA/HDEHP mixture preferably ranges from 0.3 to 0.8. Particularly preferably, the molar fraction of DMDOHEMA within the DMDOHEMA/HDEHP mixture is 0.5, which corresponds to the highest synergistic effect.

According to one particular embodiment of the process according to the invention, the metal to be extracted from the balanced acidic aqueous phase is an actinide, and in particular uranium, and the extractant is selected from DEHiBA, TOA and mixtures thereof.

According to one preferred embodiment of the process according to the invention, the organic phase solely consists of at least one extractant and a non-ionic hydrotropic agent, i.e. it comprises nothing else, especially it comprises no organic diluent. It is indeed simpler to manage two-component organic effluents on an industrial scale than multi-component organic effluents.

According to one preferred embodiment of the invention, the initial amount Q2 of hydrotropic agent present in the organic phase ranges from about 0.1 to 10 mol/L, and even more preferably from about 1.5 to 8 mol/L.

Although this does not represent one preferred embodiment of the process in accordance with the invention, the organic phase may nevertheless comprise, in addition to the extractant and the non-ionic hydrotropic agent, an aliphatic type organic diluent. In this case, the organic phase preferably comprises at least 0.5 mol/L of non-ionic hydrotropic agent, preferably at least 4 mol/L and even more preferably 5 mol/L of non-ionic hydrotropic agent.

Contacting step (iii) can be carried out by simply mixing the balanced acidic aqueous phase and the organic phase.

According to one preferred embodiment, the aqueous and organic phases are mixed in a volume ratio ranging from 1:1 to 1:4, and even more preferably in a volume ratio equal to 1:1.

Stirring step (iv) corresponds to the actual extraction step during which the metal salts initially present in the balanced acid aqueous phase pass in whole or in part into the organic phase.

Step (iv) is generally carried out at a temperature of 20 to 50° C., preferably at a temperature of 20 to 30° C., and even more preferably at a temperature of 20 to 25° C., i.e. at ambient temperature.

Separation of the organic phase from the balanced acidic aqueous phase in step (iv) may be carried out by centrifugation, for example.

According to a particular and preferred embodiment of the invention, the process is implemented in an extraction device comprising several stages, preferably operating in countercurrent, each of the stages making it possible to implement steps (iii) to (v). In this case, the process further comprises, after each step (v) and before each step (iii), at least one intermediate step of readjusting amounts of non-ionic hydrotropic agents present in the acidic aqueous phase and in the organic phase respectively to values identical to the initial values Q1 and Q2.

Metal salts extracted from the balanced aqueous acid phase and present in the organic phase after separation can then be recovered.

Thus, according to one preferred embodiment, the process further comprises at least:
a step (vi) for de-extracting salts of the metals present in the organic phase at the end of step (v), said step (vi) comprising at least contacting said organic phase with an aqueous phase referred to as the “de-extraction solution”, said solution containing at least one non-ionic hydrotropic agent in an initial amount Q3, and then
a step (vii) of separating the organic phase from said de-extraction phase to recover a de-extraction phase comprising salts of said metals.

The de-extraction solution may consist of water, especially distilled water, i.e. it comprises only water and said non-ionic hydrotropic agent, or a mixture of water and at least one acid and said non-ionic hydrotropic agent.

The initial concentration Q3 of ionic hydrotropic agent in the de-extraction solution preferably ranges from about 0.1 to 5 mol/L, and even more preferably from about 0.5 to 4 mol/L.

According to one particularly advantageous and preferred embodiment of the invention, the non-ionic hydrotropic agent present in the de-extraction solution is identical to the non-ionic hydrotropic agent of the organic phase, itself preferably being identical to the non-ionic hydrotropic agent present in the balanced acid aqueous phase.

When the de-extraction solution contains an acid, then said acid is preferably the same as that present in the balanced acidic aqueous phase.

According to one preferred embodiment of the invention, steps (vi) and (vii) are carried out in a multi-stage de-extraction battery, preferably operating in countercurrent with each of the stages enabling steps (vi) and (vii) to be carried out. In this case, the process in accordance with the invention further comprises, after each step (vii) and before each step (vi), at least one intermediate step of readjusting the amount of non-ionic hydrotropic agent present in the de-extraction solution to a value identical to the initial value Q3.

A second object of the invention is the use of an organic phase as defined above, i.e. comprising at least one extractant and a non-ionic hydrotropic agent for extracting a metal selected from elements of the rare earths group and the actinides group from an acidic aqueous phase containing said metals and a non-ionic hydrotropic agent.

According to this use, the organic phase preferably comprises only one or more extractants and a non-ionic hydrotropic agent. In this case, said organic phase does not comprise anything else, especially it does not comprise any organic diluent.

According to one preferred embodiment of this use, the non-ionic hydrotropic agent of the organic phase is identical to the non-ionic hydrotropic agent of the acidic aqueous phase.

### EXAMPLES

The experimental results reported in the following examples have been obtained using acidic aqueous phases comprising light rare earths, namely lanthanum (La) and/or neodymium (Nd), and heavy rare earths, namely europium (Eu), dysprosium (Dy), erbium (Er) and/or ytterbium (Yb) or an actinide, namely uranium. In order to evaluate selectivity of the extraction systems studied, iron has been also added to the aqueous phase.

As extractants, bis(2-ethylhexyl) phosphoric acid (HDEHP) and N,N′-dimethyl,N,N′-dioctylhexylethoxymalonamide (DMDOHEMA) have been used to extract rare earths, while uranium has been extracted using di-ethylhexyl isobutyramide (DEHiBA) or trioctylamine (TOA). These elements have been extracted from an aqueous solution of nitric, sulphuric, phosphoric or hydrochloric acid by bringing a pre-balanced aqueous solution containing the element(s) to be extracted into contact with an organic phase comprising the extractant at a concentration of 0.1 to 2 mol/L diluted in one of the following hydrotropic agents (diluents): 1-propoxy-2-propanol (PnP), dipropylene glycol n-propyl ether (DPnP) or ethylene glycol monopentyl ether (C₅E₁). The results obtained have then been compared with those obtained by dissolving the same extractants in “conventional” aliphatic or aromatic diluents such as n-dodecane, hydrogenated tetrapropylene (TPH), toluene, isooctane or isoparaffinic solvents such as Isane® (IP-175).

The distribution coefficients, extraction yields and selectivity coefficients, which are reported in the following examples, have been determined in accordance with conventions in the field of liquid-liquid extractions, namely that:
the distribution coefficient of a metal element M, denoted DM, between two, respectively organic and aqueous, phases is determined by the following equation (2):

$$\begin{matrix}[ Equation 2 ] & \\ {D}_{M} = \frac{{[ M ]}_{org}}{{[ M ]}_{aq}} & ( 2 )\end{matrix}$$

wherein:
[M]_{org} is the concentration of the metal element M in the organic phase after extraction,
[M]_{aq} is the concentration of the metal element M in the aqueous phase after extraction.
the extraction yield of a metal element M, noted E_{M}, from an aqueous phase is determined by the following equation (3):

$$\begin{matrix}[ Equation 3 ] & \\ {E}_{M} = \frac{{[ M ]}_{org}}{{[ M ]}_{aq\_initial}} = \frac{{D}_{M}}{{D}_{M} + 1} & ( 3 )\end{matrix}$$

wherein:
[M]_{org}, and D_{M} have the same meaning as previously; whereas [M]_{aq,initial} is the concentration of the metal element M in the aqueous phase before extraction; whereas the selectivity coefficient of a metal element M1 with respect to a metal element M2, denoted S_{M1/M2}, is determined by the following equation (4):

$$\begin{matrix}[ Equation 4 ] & \\ {S}_{M 1 / M 2} = \frac{{D}_{M 1}}{{D}_{M 2}} & ( 4 )\end{matrix}$$

wherein:
D_{M1} is the distribution coefficient of the metal element M1, and
D_{M2} is the distribution coefficient of the metal element M2.

### Example 1: Separation of Lanthanides (La, Nd, Eu, Dy, Er and Yb) According to the Process of the Invention Using an Anionic Extractant (HDEHP)

### 1.1 Influence of the Nature of the Acid

Tests aimed at extracting rare earths from an acidic aqueous phase have first been carried out in tubes using:
as organic phases: phases consisting of the extractant HDEHP at a concentration set to 0.6 mol/L diluted in PnP. In order to be able to compare the results of extraction experiments according to the process in accordance with the invention with a comparative extraction process not being part of the invention, extraction experiments using conventional solvents have been carried out in parallel. For comparison, the isoparaffinic solvent Isane® IP 175 has been taken as the benchmark; and
as aqueous phases: aqueous solutions pre-balanced with PnP alone comprising 10 mM hydrated europium nitrate, and 0.03 M or 1 M nitric acid, phosphoric acid, sulphuric acid or hydrochloric acid in a PnP/aqueous phase volume ratio of 3:1.

The organic and aqueous phases have been brought into contact with each other in an organic phase (Org)/aqueous phase (Aq) ratio (Org/Aq) of 1 (v/v), for 1 h, at ambient temperature and with rotary stirring. The organic and aqueous phases have then been separated by centrifugation at 5000 rpm for 20 min. The concentrations of europium have been measured in the aqueous and organic phases thus recovered by inductively coupled plasma-atomic emission spectrometry (ICP-AES, Spectro Arcos apparatus marketed by AMETEK) and energy dispersive X-ray fluorescence spectrometry (EDXRF-SPECTRO apparatus, XEPOS model, marketed by AMETEK).

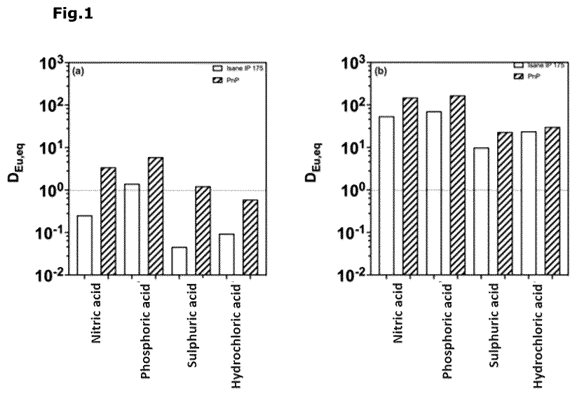

The results of these tests are reported in appended FIG. 1, which represents the distribution coefficients of Europium, D_{Eu}, as a function of the nature of acid used. In these figures, the results given by white bars correspond to the comparative extraction process not in accordance with the invention and carried out using Isane IP 175 as the solvent, and hatched bars correspond to the extraction process in accordance with the present invention and carried out using PnP as the hydrotropic agent. FIG. 1 (a) shows the case where the concentration of the different acids employed has been set to 1 M, while FIG. 1 (b) shows the case where the concentration has been set to 0.03 M.

As shown in FIG. 1 (a), at an acid concentration of 1 M, no measurable extraction of europium is noticed when the HDEHP extractant is diluted in Isane IP 175. On the other hand, these results show that the extraction of europium by the HDEHP extractant is greatly promoted by replacing Isane IP 175 with PnP in the organic phase, since an increase in the distribution coefficient of at least a factor of 10 is observed.

FIG. 1 (b) shows that by extracting europium using Isane IP 175 as the solvent and at a concentration of 0.03 M acid, the distribution coefficients have increased considerably compared with FIG. 1 (a) and a clear improvement in extraction is observed in the case of PnP with at least a factor of 2. This is consistent with the literature which, to the best of the inventors' knowledge, does not mention any study showing the possibility of extracting rare earths from an aqueous phase with an acidity greater than or equal to 1 M with conventional diluents.

1.2. Study of Selectivity with Respect to Iron

The selectivity of the extraction of rare earths with respect to iron, which is the main impurity in all the processes, has been assessed by tests carried out in tubes using:
as organic phases: phases comprising, as the extractant, HDEHP at a concentration set to 0.6 mol/L diluted in PnP. In order to be able to compare the results of extraction experiments according to the process in accordance with the invention with a comparative extraction process not being part of the invention, extraction experiments using conventional solvents have been carried out in parallel. For comparison, the isoparaffinic solvent Isane® IP 175 has been taken as the benchmark; and
as aqueous phase: aqueous solutions comprising lanthanum (La), neodymium (Nd), europium (Eu), dysprosium (Dy), erbium (Er), ytterbium (Yb) and iron (Fe) at rare earth concentrations of 10 mM each and 30 mM for iron. These aqueous solutions have been diluted in an acidic solution comprising 1 M nitric, phosphoric, sulphuric or hydrochloric acid.

The organic and aqueous phases have been brought into contact with each other at an Org/Aq ratio of 1 (v/v) for 1 hour at ambient temperature with rotary stirring. The organic and aqueous phases have then been separated by centrifugation at 5000 rpm for 20 minutes. The concentrations of rare earths and iron have been measured in the aqueous and organic phases thus recovered (ICP-AES and EDXRF as indicated above in section 1.1).

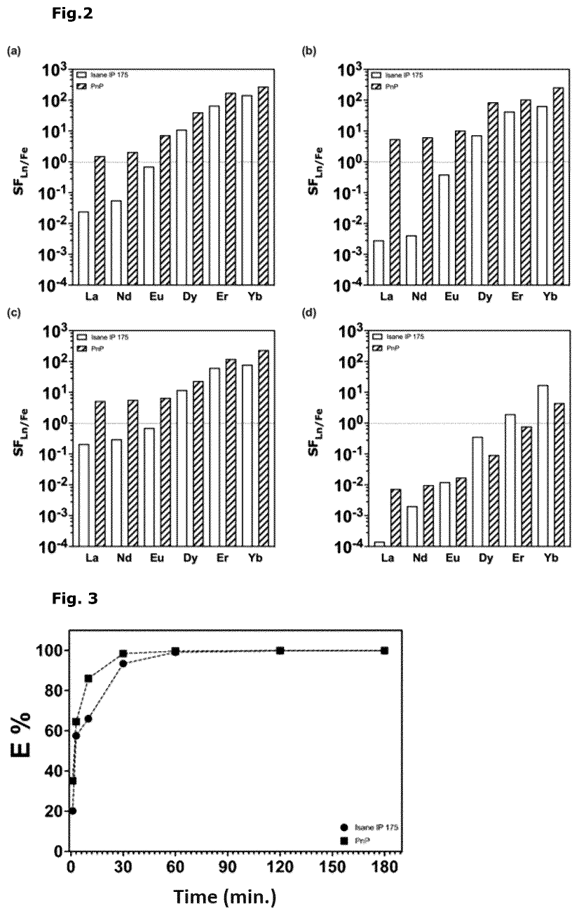

The results of these tests are reported in appended FIG. 2, which represents the selectivity coefficients of rare earths with respect to iron, noted SF_{Ln/Fe}, for the different acids used: (a) nitric, (b) phosphoric, (c) sulphuric and (d) hydrochloric acids. In these figures, the results given by white bars correspond to the comparative extraction process not in accordance with the invention and carried out using Isane IP 175 as the solvent, and hatched bars correspond to the extraction process in accordance with the present invention and carried out using PnP as the hydrotropic agent.

As shown by these figures, the selectivity of the process with regard to the extraction of all the rare earths with respect to iron is dramatically improved with the replacement of Isane IP 175 with PnP in accordance with the process according to the present invention.

### 1.3 Extraction Kinetics

The influence of time on the extraction efficiency has been assessed by tests carried out in tubes using:
as organic phases: phases comprising, as the extractant, HDEHP at a concentration set to 0.6 mol/L diluted in PnP. In order to be able to compare the results of extraction experiments according to the process in accordance with the invention with a comparative extraction process not being part of the invention, extraction experiments using conventional solvents have been carried out in parallel. For comparison, the isoparaffinic solvent Isane® IP 175 has been taken as the benchmark; and
as aqueous phase: aqueous solutions comprising 10 mM europium (Eu) in an acidic solution comprising 0.03 mol/L nitric acid in ultra-pure water (i.e. Milli-Q water, with a resistivity greater than 18 MΩ/cm at 25° C.).

The organic and aqueous phases have been brought into contact with each other in an Org/Aq ratio of 1 (v/v), for 1, 3, 10, 30, 60, 120 and 180 min, at ambient temperature and with rotary stirring. The organic and aqueous phases have then been separated by centrifugation at 5000 rpm for 20 minutes. The concentrations of europium have been measured in the aqueous and organic phases thus recovered (ICP-AES and EDXRF as indicated above in section 1.1).

The results of these tests are reported in appended FIG. 3, which represents the variation in europium extraction yield (E in %) as a function of time (in min.). In this figure, the curve with solid circles corresponds to the experiments carried out using Isane® IP 175 as the solvent according to a process not in accordance with the invention and the curve with solid squares corresponds to the experiments carried out using PnP as the hydrotropic agent according to the process in accordance with the invention.

As shown by the results set forth in FIG. 3, the europium extraction kinetics are faster and reach a yield plateau of 80% after 10 min and 99% after 30 min using PnP according to the process in accordance with the invention, whereas it takes twice as long, i.e. 60 min, to obtain the same 99% yield with the process not in accordance with the invention.

1.4 Viscosity of the Organic Phases after Extraction

Viscosity in the organic phase is a crucial parameter on an industrial scale that needs to be taken into account. To this end, the influence of the concentration of salts and of the extractant on the viscosity of the organic phases after extraction has been assessed by tests carried out in tubes using:
as organic phases: phases containing the extractant HDEHP at concentrations ranging from 0.6 mol/L to 2 mol/L diluted in PnP. In order to be able to compare the results of extraction experiments according to the process in accordance with the invention with a comparative extraction process not being part of the invention, extraction experiments implementing conventional solvents have been carried out in parallel. For comparison, the isoparaffinic solvent Isane® IP 175 has been taken as the benchmark; and
as aqueous phase: aqueous solutions comprising 10 mM dysprosium (Dy) in an acidic solution comprising 0.03 mol/L nitric acid in ultra-pure water (i.e. Milli-Q water, with a resistivity greater than 18 MΩ/cm at 25° C.).

The organic and aqueous phases have been brought into contact with each other in an Org/Aa ratio of 1 (v/v), for 60 min, at ambient temperature and with rotary stirring. The organic and aqueous phases have then been separated by centrifugation at 5000 rpm for 20 minutes. The viscosities of the organic phases have been measured at 25° C., before and after extraction, using an automated rolling ball viscometer, reference AMVn (Anton Paar, Graz, Austria).

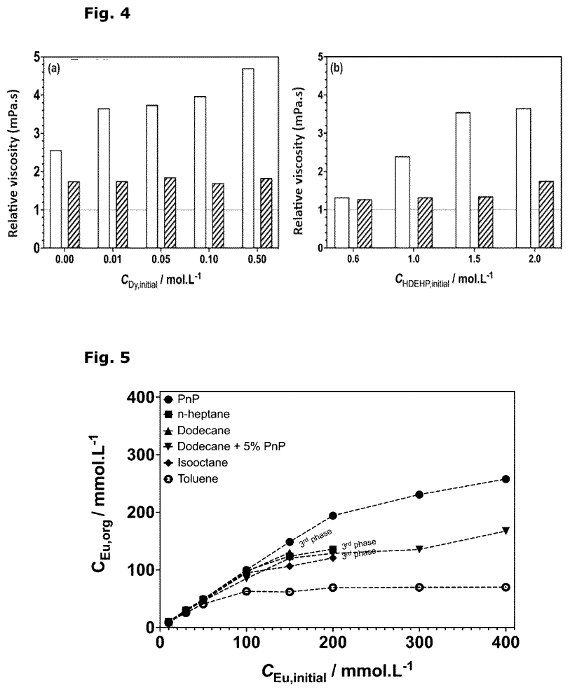

The results of these tests are reported in appended FIG. 4, in which the relative viscosity (in mPa·s) is expressed as a function of the initial dysprosium concentration (C_{Dy.initial} in mol·L⁻¹) (FIG. 4a) or as a function of the initial extractant concentration (C_{HDEHP.initial} in mol·L⁻¹) (FIG. 4b). In these figures, the results given by white bars correspond to the comparative extraction process not in accordance with the invention and carried out with Isane IP 175 as solvent and hatched bars correspond to the extraction process in accordance with the present invention and carried out using PnP as hydrotropic agent.

As shown in FIG. 4, when the extraction is carried out according to the process in accordance with the present invention, the relative viscosity of the aqueous phase hardly varies with the concentration of dysprosium in the aqueous phase and varies very little as a function of the concentration of the extractant and does not exceed 1.5 times the viscosity of the organic phase before extraction. On the other hand, when the extraction is carried out using Isane IP 175 according to the comparative process not in accordance with the invention, it is observed that the viscosity of the organic phase after extraction can increase by up to 5 times compared with the viscosity before extraction.

### 1.5. Loading Capacity

In order to evaluate efficiency of the extraction process in accordance with the present invention, loading capacity tests have been carried out and compared with loading capacities of extraction systems employing “conventional” diluents.

Loading capacity tests have been assessed and carried out in tubes using:
as organic phases: phases comprising, as the extractant, HDEHP at a concentration set to 0.6 mol/L diluted in PnP. In order to be able to compare the results of extraction experiments according to the process in accordance with the invention with a comparative extraction process not being part of the invention, extraction experiments implementing conventional solvents have been carried out in parallel, namely with n-heptane, dodecane, isooctane and toluene.
As aqueous phase: aqueous solutions comprising europium (Eu) at concentrations ranging from 10 mmol/L to 400 mmol/L in an acidic solution comprising 0.03 mol/L nitric acid in ultra-pure water (i.e. Milli-Q water, with a resistivity greater than 18 MΩ/cm at 25° C.).

The organic and aqueous phases have been brought into contact with each other at an Org/Aq ratio of 1 (v/v), for 60 min, at ambient temperature and with rotary stirring. The organic and aqueous phases have then been separated by centrifugation at 5000 rpm for 20 minutes. The concentrations of europium have been measured in the aqueous and organic phases thus recovered (ICP-AES and EDXRF as indicated above in section 1.1).

The results of these tests are reported in appended FIG. 5, which represents the variation in the concentration of europium in the organic phase at equilibrium, noted C_{Eu,org} and expressed in mmol·L⁻¹, as a function of the concentration of europium in the initial aqueous phases (C_{Eu}, initial/mmol·L⁻¹). In this figure, the curve with solid lines corresponds to extraction in the presence of PnP according to the process in accordance with the invention. The other curves correspond to extractions carried out with conventional solvents according to processes not in accordance with the invention: curve with solid squares n-heptane, curve with solid triangles peak upwards: dodecane, curve with solid triangles peak downwards: dodecane+5% PnP, curve with solid diamonds: isooctane and curve with empty circles: toluene.

FIG. 5 shows that beginning of saturation of the europium extraction is observed in the case of heptane, dodecane, isooctane and toluene, with the formation of a 3rd phase for the first three diluents. On the other hand, neither saturation nor 3rd phase has been observed for PnP according to the process of the invention, and a loading capacity greater than 250 mmol/L can be expected for concentrations of europium in the aqueous phase greater than 400 mmol/L. In the case of the n-dodecane+5% PnP mixture, the loading capacity is lower than when the n-dodecane is completely replaced with PnP. Nevertheless, the 3rd phase is also avoided in the concentration range tested, even with a PnP amount of 5%.

In any case, these results show the possibility of loading the organic phase with rare earths using PnP above 400 mmol/L, which usually represents the loading limit of extraction systems conventionally used in the field of rare earth extraction.

### 1.6 Influence of the Acidity of the Aqueous Phase and the Concentration of the Extractant in the Organic Phase

The influence of the acidity of the nitric aqueous phase and of the concentration of the extractant in the organic phase on the ability of this system to extract europium has been assessed by tests which have been carried out in tubes using:
as organic phases: phases comprising, as the extractant, HDEHP at concentrations ranging from 0.01 mol/L to 3 mol/L diluted in PnP. In order to be able to compare the results of extraction experiments according to the process in accordance with the invention with a comparative extraction process not being part of the invention, extraction experiments implementing a conventional solvent have been carried out in parallel with dodecane.
As aqueous phase: aqueous solutions comprising 10 mmol/L of europium (Eu) in a nitric acid solution at concentrations ranging from 0.1 mol/L to 3 mol/L nitric acid in ultra-pure water (i.e. Milli-Q water, with a resistivity greater than 18 MΩ/cm at 25° C.).

The organic and aqueous phases have been brought into contact with each other in an Org/Aq ratio of 1 (v/v), for 60 min, at ambient temperature and with rotary stirring, and then separated by centrifugation at 5000 rpm for 20 minutes. The concentrations of europium have been measured in the aqueous and organic phases thus recovered (ICP-AES and EDXRF as indicated above in section 1.1).

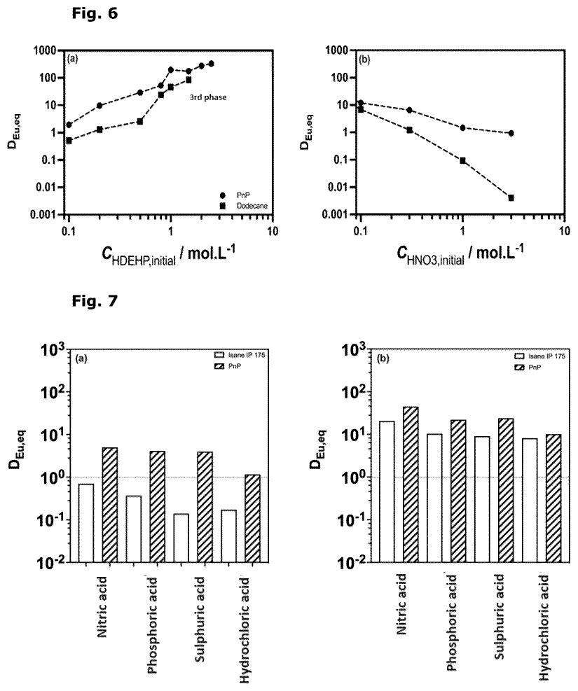

The results of these tests are reported in appended FIG. 6. FIG. 6 (a) sets forth variation in the europium distribution coefficient (D_{Eu,eq}) as a function of the initial concentration of HDEHP (C_{HDEHP, initial}) in mol·L⁻¹ in the organic phase, while FIG. 6 (b) shows the variation in the europium distribution coefficient (D_{Eu,eq}) as a function of the initial nitric acid concentration in the aqueous phase (C_{HNO3, initial}) in mol·L⁻¹. In this figure, the curves with solid circles correspond to the extraction carried out using PnP according to the process of the invention, whereas the curves with solid squares correspond to the extraction carried out using dodecane according to a process not being part of the invention.

FIG. 6 (a) shows that increasing the concentration of extractant improves efficiency of the extraction without the appearance of a 3rd phase for the PnP according to the process in accordance with the invention, unlike what is observed using a conventional solvent, dodecane, according to a process not being part of the invention. FIG. 6 (b) shows that increasing the acidity of the aqueous phase results in a gradual decrease in the extraction of europium by PnP. Beyond 1 mol/L nitric acid, the values of the distribution coefficient tend towards zero for the extraction process carried out with dodecane, whereas the decrease in the distribution coefficient remains negligible when the extraction is carried out in the presence of PnP. This extends the range of acid concentrations to be used according to the process in accordance with the invention.

### Example 2: Process for Separating Lanthanides: La, Nd, Eu, Dy, Er and Yb According to the Process in Accordance with the Invention Using DMDOHEMA as the Extractant

### 2.1 Influence of the Nature of the Acid

Tests aimed at extracting rare earths from an acidic aqueous phase have first been carried out in tubes using:
as organic phases: phases consisting of the extractant DMDOHEMA at a concentration set to 0.6 mol/L diluted in PnP. In order to be able to compare the results of extraction experiments according to the process in accordance with the invention with a comparative extraction process not being part of the invention, extraction experiments using conventional solvents have been carried out in parallel. For comparison, the isoparaffinic solvent Isane® IP 175 has been taken as the benchmark; and
as aqueous phases: aqueous solutions pre-balanced with PnP alone comprising 10 mM hydrated europium nitrate, 1 M or 3 M nitric, phosphoric, sulphuric or hydrochloric acid.

The organic and aqueous phases have been brought into contact with each other at an Org/Aq ratio of 1 (v/v), for 1 h, at ambient temperature and with rotary stirring, and then separated by centrifugation at a speed of 5,000 rpm for 20 min. The concentrations of europium have been measured in the aqueous and organic phases thus recovered (ICP-AES and EDXRF as indicated in example 1 above in section 1.1).

The results of these tests are reported in appended FIG. 7, which represents the distribution coefficients of Europium, noted D_{Eu,eq}, as a function of the nature of the acid used. FIG. 7 (a) shows the case where the concentration of the different acids used is set to 1 M, whereas in FIG. 7 (b) the concentration is set to 3 M. In these figures, white bars correspond to the results obtained by implementing an extraction process using Isane® IP175 not in accordance with the invention, whereas hatched bars correspond to the results obtained by implementing an extraction process in accordance with the invention and using PnP.

As shown in FIG. 7 (a), at a concentration of 1 M acid, no measurable extraction of europium is noticed when the extractant is diluted in Isane® IP 175. On the other hand, the extraction of europium is promoted when Isane® IP 175 is replaced with PnP in the organic phase and an increase in the distribution coefficient of at least a factor of 20 is noticed.

FIG. 7 (b) shows that with Isane® IP 175 as diluent and at 3 M concentration of extractant, the distribution coefficients have dramatically increased in comparison with FIG. 7 (a) and a clear improvement in extraction is noticed in the case of PnP with at least a factor of 2.

### 2.2 Loading Capacity

In order to evaluate efficiency of the extraction process in accordance with the invention, loading capacity tests have been carried out and compared with the loading capacities of extraction systems employing “conventional” diluents.

Loading capacity tests have been assessed and carried out in tubes using:
as organic phases: phases comprising the extractant DMDOHEMA at a concentration set to 0.6 mol/L diluted in PnP. In order to be able to compare the results, extraction experiments with conventional diluents have been carried out in parallel with dodecane.
As aqueous phase: aqueous solutions comprising concentrations ranging from 10 mmol/L to 400 mmol/L of europium (Eu) in an acidic solution comprising 3 mol/L of nitric acid in ultra-pure water (i.e. Milli-Q water, with a resistivity greater than 18 MΩ/cm at 25° C.);

The organic and aqueous phases have been brought into contact with each other at an Org/Aq ratio of 1 (v/v), for 60 min, at ambient temperature and with rotary stirring, and then separated by centrifugation at a speed of 5000 rpm for 20 min. The concentrations of europium have been measured in the aqueous and organic phases thus recovered (ICP-AES and EDXRF as indicated in example 1 above in section 1.1).

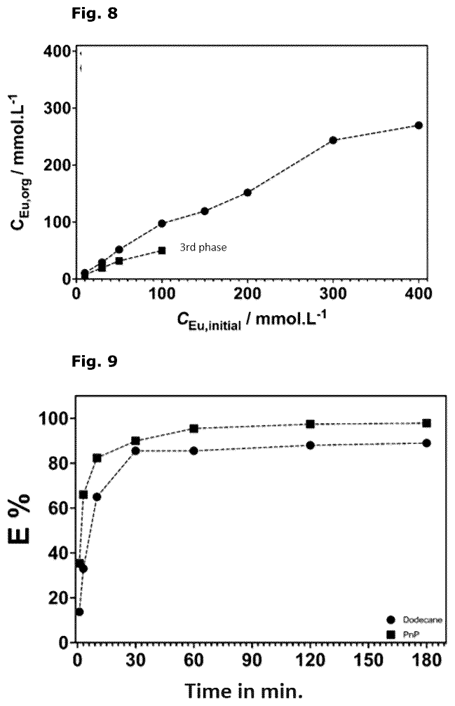

The results of these tests are reported in appended FIG. 8, which represents the variation in the concentration of europium in the organic phase at equilibrium, noted C_{Eu,eq} and expressed in mmol/L, as a function of the concentration of europium in the initial aqueous phases (C_{Eu,initial} in mmol·L⁻¹). In this figure, the curve with solid circles corresponds to the results obtained by implementing the extraction process in accordance with the invention and using PnP, whereas the curve with solid squares corresponds to the results obtained by implementing the extraction process not in accordance with the invention and using dodecane.

FIG. 8 shows that beginning of saturation of the europium extraction is observed in dodecane with the formation of a 3rd phase. On the other hand, neither saturation nor 3rd phase has been observed for PnP, and a loading capacity greater than 250 mmol/L can be expected for europium concentrations in the aqueous phase greater than 400 mmol/L.

In any case, these results show the possibility of loading the organic phase with rare earths using PnP above 400 mmol/L, which represents the loading limit of extraction systems conventionally used in the field of rare earth extraction.

### 2.3 Extraction Kinetics

The influence of time on extraction efficiency has been assessed by tests carried out in tubes using:
As organic phases: phases comprising DMDOHEMA as the extractant at a concentration set to 0.6 mol/L diluted in PnP. In order to be able to compare the results, extraction experiments with conventional diluents have been carried out in parallel with dodecane; and
As aqueous phase: aqueous solutions comprising 10 mM europium (Eu) in an acidic solution comprising 3 mol/L nitric acid in ultra-pure water (i.e. Milli-Q water, with a resistivity greater than 18 MΩ/cm at 25° C.).

The organic and aqueous phases have been brought into contact with each other in an Org/Aq ratio of 1 (v/v), for 1, 3, 10, 30, 60, 120 or 180 min, at ambient temperature and with rotary stirring, and then separated by centrifugation at a speed of 5000 rpm for 20 min. The concentrations of europium have been measured in the aqueous and organic phases thus recovered (ICP-AES and EDXRF as indicated in example 1 above in section 1.1).

The results obtained are reported in appended FIG. 9, in which the variation in the extraction yield of europium (E %) is expressed as a function of time (in min.). In this figure, the curve with solid squares corresponds to the results obtained by implementing the process in accordance with the invention using PnP, whereas the curve with solid circles corresponds to the results obtained by implementing a process not in accordance with the invention and using dodecane as the solvent for the extractant.

As shown in FIG. 9, the extraction kinetics of europium is faster and reaches a yield value of 80% after 15 min and a yield plateau of 99% after 60 min using PnP in accordance with the process of the invention.

### Example 3: Extraction Process in Accordance with the Invention Using Two Extractants in Anionic and Solvating Synergy (HDEHP and DMDOHEMA) for the Separation of the Lanthanides: Lanthanum, Neodymium, Europium, Dysprosium, Erbium and Ytterbium

The synergistic effect of a mixture of HDEHP and DMDOHEMA on the extraction of rare earths from an aqueous nitric acidic solution, as well as the influence of the DMDOHEMA/HDEHP molar ratio of this mixture on these extracting properties have been assessed by extraction tests made using the following phases:
as aqueous phase: phases obtained by dissolving five rare earth salts in oxidation state (III) in the respective forms: La(NO₃)₃, Nd(NO₃)₃, Eu(NO₃)₃, Dy(NO₃)₃ and Yb(NO₃)₃, at 10 mmol/L of each of these salts, in solutions comprising 1 mol/L nitric acid in ultra-pure water (i. i.e. Milli-Q water, with a resistivity greater than 18 MΩ/cm at 25° C.); and
as organic phases: phases comprising 0.6 mol/L of an extractant in PnP, this extractant consisting either solely of DMDOHEMA, solely of HDEHP, or of a mixture of DMDOHEMA and HDEHP in which the molar ratio of DMDOHEMA to HDEHP is varied (from 0 to 1). In order to be able to compare the results, similar extraction experiments but with a conventional diluent have been carried out in parallel with Isane® IP175.

As iron is naturally present as a major impurity in ores, and especially natural ores, the aqueous phases further comprised 30 mmol/L iron (III) nitrate.

Extraction tests have been carried out using an aqueous phase/organic phase (Aq/Org) volume ratio of 1 (v/v). The aqueous and organic phases have been brought into contact for 1 hour at a constant temperature (25° C.), after which they have been separated from each other by centrifugation (5000 rpm) for 20 minutes at 25° C. The concentrations of rare earths have been measured in the aqueous and organic phases thus recovered (ICP-AES and EDXRF as indicated in example 1 above in section 1.1).

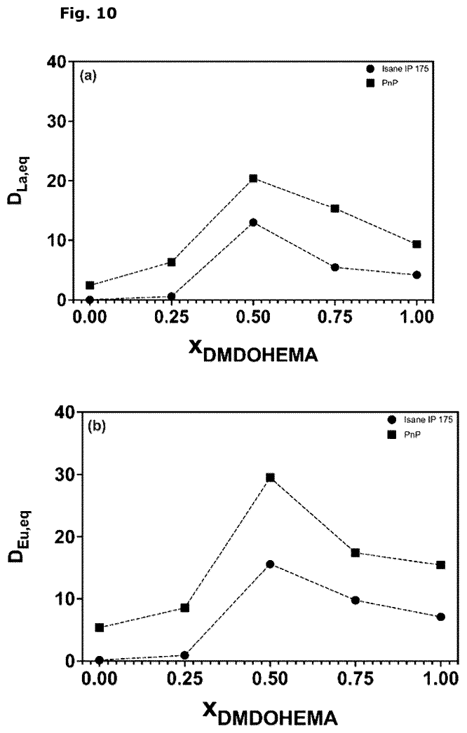

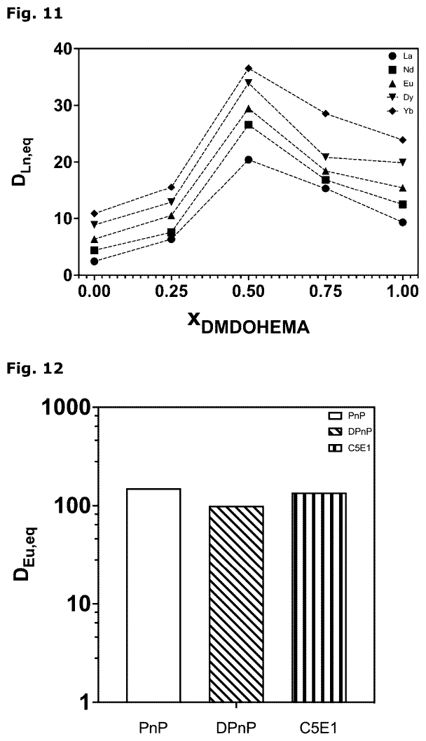

The results of these tests are presented in appended FIGS. 10 and 11, in which the distribution coefficients of the rare earths, noted D_{Ln,eq}, are indicated as a function of the molar fraction of DMDOHEMA with respect to HDEHP, noted x_{DMDOHEMA}. In these figures, the curves with solid squares correspond to the results obtained by implementing the process in accordance with the invention and using PnP, whereas the curves with solid circles correspond to the results obtained by implementing the process not in accordance with the invention and using Isane® IP175.

FIG. 10 compares the distribution coefficients of lanthanum (FIG. 10 (a)) and europium (FIG. 10 (b)) in the case of PnP (solid squares) and Isane® IP 175 (solid circles), as a function of the molar fraction X of DMDOHEMA noted X_{DMDOHEMA}.

FIG. 11 shows the course of the distribution coefficients of the different lanthanides noted DLn, eq, as a function of the molar fraction X of the extractant DMDOHEMA, noted X_{DMDOHEMA}. In this figure, La=curve with solid circles, Nd=curve with solid squares, Eu=curve with solid triangles peak upwards, Dy=curve with solid triangles peak downwards, and Yb=curve with solid diamonds.

In FIGS. 10 and 11, the results given for x_{DMDOHEMA}=0 correspond to the results obtained when the extractant solely consists of HDEHP, while the results given for x_{DMDOHEMA}=1 correspond to the results obtained when the extractant solely consists of DMDOHEMA.

These results show that, for all the rare earths, the extraction yields obtained with an extractant consisting of a mixture of DMDOHEMA and HDEHP are greater than the sum of the extraction yields obtained, on the one hand, by an extractant solely consisting of DMDOHEMA and, on the other hand, with an extractant solely consisting of HDEHP, which highlights a synergistic effect of the mixture of DMDOHEMA and HDEHP on the extraction of all these rare earths.

They also show that the highest synergistic effect of the mixture of DMDOHEMA and HDEHP is observed for a DMDOHEMA molar fraction of 0.5 and higher extraction yields in the case of PnP in comparison with dodecane.

### Example 4: Extraction of Earths According to the Process in Accordance with the Invention and Using PnP, DPnP or C₅E₁ as the Hydrotropic Agent

Tests aimed at replacing the hydrotrope PnP with other co-solvent hydrotropic agents to extract rare earths from an acidic aqueous phase have first been carried out in tubes using:
as organic phases: phases comprising, as the extractant, HDEHP at a concentration set to 0.6 mol/L diluted in PnP, DPnP or C₅E₁; and
as aqueous phases: aqueous solutions pre-balanced with the hydrotropic agent to be used alone and comprising 10 mM hydrated europium nitrate and 0.03 M nitric acid.

The organic and aqueous phases have been brought into contact with each other at an Org/Aq ratio of 1 (v/v), for 1 h, at ambient temperature and with rotary stirring, and then separated by centrifugation at a speed of 5000 rpm for 20 min. The concentrations of europium have been measured in the aqueous and organic phases thus recovered (ICP-AES and EDXRF as indicated in example 1 above in section 1.1).

The results of these tests are reported in appended FIG. 12, which represents the distribution coefficients of europium, noted D_{Eu}, as a function of the nature of the hydrotropic agent used. In this figure, the europium distribution coefficients (D_{EU.eq}) are given for each of the hydrotropic agents used: white bar corresponds to PnP, diagonally hatched bar corresponds to DPnP and vertically hatched bar corresponds to C₅E₁. As shown in FIG. 12, all three hydrotropes are effective in extracting rare earths.

### Example 5: Extraction Process in Accordance with the Invention Including a Preliminary Leaching Step and Using Weak Organic Acids for Leaching, Extraction and De-Extraction

In this example, the extraction of europium has been carried out under “mild” or “green” conditions, i.e. without using a strong acid.

Tests aimed at extracting rare earths from an aqueous phase comprising a weak acid such as acetic acid have first been carried out in tubes using:
as organic phases: phases comprising, as the extractant, HDEHP or DMDOHEMA at a concentration set to 0.6 mol/L diluted in PnP. In order to be able to compare the results, extraction experiments with a conventional diluent have been carried out in parallel with dodecane; and
as aqueous phases: aqueous solutions pre-balanced with PnP alone and comprising 10 mM hydrated europium nitrate and 1 M to 6 M acetic acid.

The organic and aqueous phases have been brought into contact with each other in an Org/Aq ratio of 1 (v/v), for 1 h, at ambient temperature and with rotary stirring, and then separated by centrifugation at a speed of 5000 rpm for 20 min. The concentrations of europium have been measured in the aqueous and organic phases thus recovered (ICP-AES and EDXRF as indicated in example 1 above in section 1.1).

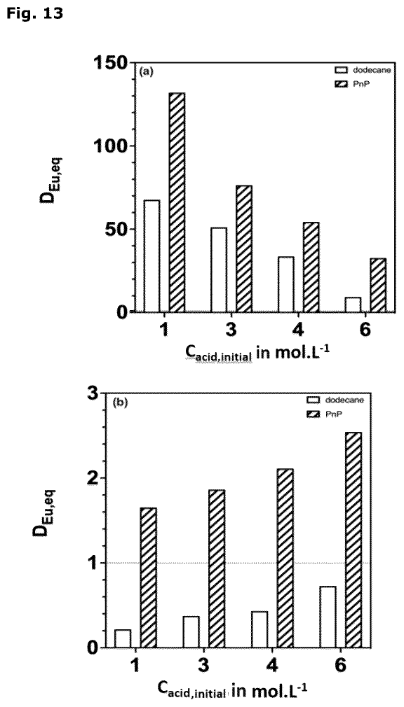

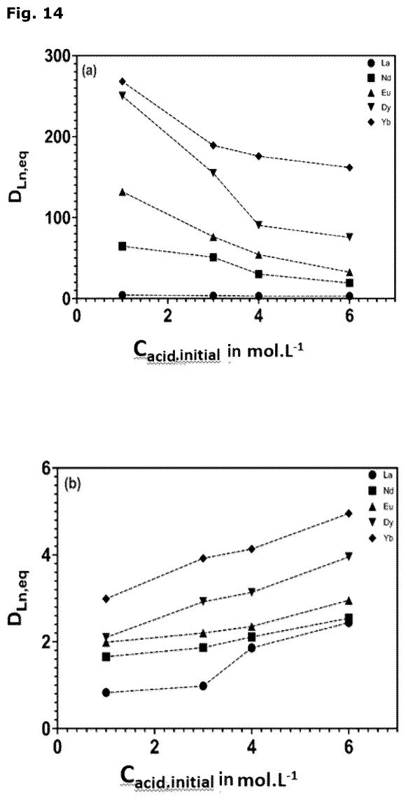

The results of these tests are reported in appended FIGS. 13 and 14. FIG. 13 represents the distribution coefficients of Europium, noted D_{Eu,eq}, as a function of the concentration of acetic acid. FIG. 13 (a) shows the case where the process has been implemented with HDEHP as the extractant, whereas in FIG. 13 (b) the extractant used is DMDOHEMA.

FIG. 14 shows the course of the rare earth distribution coefficients (D_{L,eq}) as a function of initial acidity of the aqueous phase (C_{acid, initial} in mol·L⁻¹) for two different extractants. FIG. 14 (a): HDEHP and FIG. 14 (b): DMDOHEMA. In these FIGS. 13 and 14, the curves correspond to: solid circles: La; solid squares: Nd; solid triangles peak upwards: Eu; solid triangles peak downwards: Dy; and solid diamonds Yb.

As shown in FIG. 13 (a), the extraction of europium with HDEHP is effective and considerably improved by replacing dodecane with PnP by a factor of at least 2.

In FIG. 13 (b), no measurable extraction of europium is noticed in the case where the extractant is diluted in dodecane while extraction becomes effective (distribution coefficient increases from 0.6 to 2.8 in 6 M acetic acid). Thus, according to the extraction process in accordance with the present invention, employing a hydrotropic agent dispenses with the presence of a strong acid. The use of a hydrotropic agent acting as a co-solvent makes it possible to implement known extraction processes with strong acids, but which are not sufficiently efficient, without having to synthesise complicated new organic molecules. In this example of implementation of the process in accordance with the invention, a synergy of actions of the hydrated weak organic acid and of all the hydrotropic agents is observed.

In FIG. 14 (a), extraction efficiency decreases drastically with increasing acidity for light rare earths and very little for heavy rare earths. Acidity plays an important role in extraction efficiency and induces selectivity between light and heavy rare earths. FIG. 14 (b) shows that with DMDOHEMA the effect is the opposite. Extraction is more efficient at higher acetic acid concentrations.

### Example 6: Extraction of Uranium According to the Process in Accordance with the Invention

Tests aimed at extracting uranium from an acidic aqueous phase have first been carried out in tubes using:
As organic phases: phases comprising, as the extractant, DEHiBA or TOA at a variable concentration of 0.01 to 2 mol/L diluted in PnP. In order to be able to compare the results, extraction experiments with conventional diluents have been carried out in parallel, especially with dodecane, toluene, TPH and isooctane.
As aqueous phases: aqueous solutions pre-balanced with PnP alone comprising 250 ppm of uranium nitrate or sulphate diluted in 3 M nitric or sulphuric acid.

The organic and aqueous phases have been brought into contact with each other in an Org/Aq ratio of 1 (v/v), for 1 h, at ambient temperature and with rotary stirring, and then separated by centrifugation at a speed of 5000 rpm for 20 min. The concentrations of europium have been measured in the aqueous and organic phases thus recovered (ICP-AES and EDXRF as indicated in example 1 above in section 1.1).

The results of these tests are illustrated in FIG. 15, which represents the distribution coefficients of uranium, noted Du (in mol·L⁻¹) as a function of the concentration of DEHiBA diluted in different solvents (solid circles: TPH, solid squares: dodecane, solid triangles peak upwards: toluene and solid triangles peak downwards: PnP).

FIG. 15 shows that uranium extraction is much better with PnP, with neither the appearance of a 3rd phase nor an increase in the viscosity of the organic phase, than with conventional solvents.

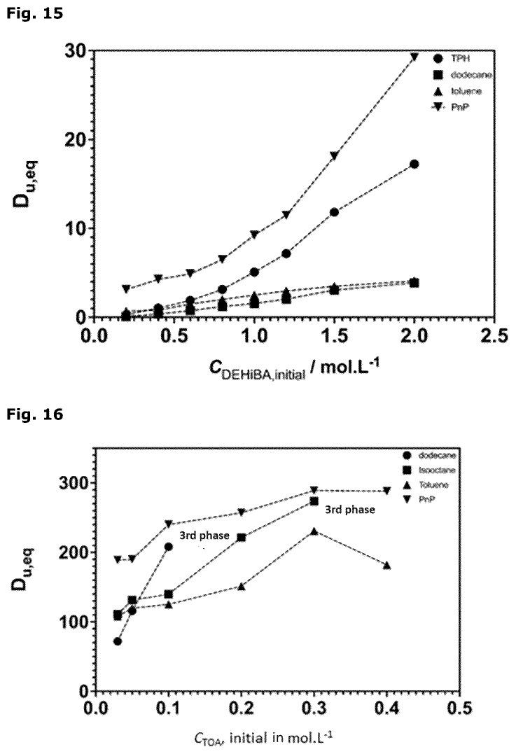

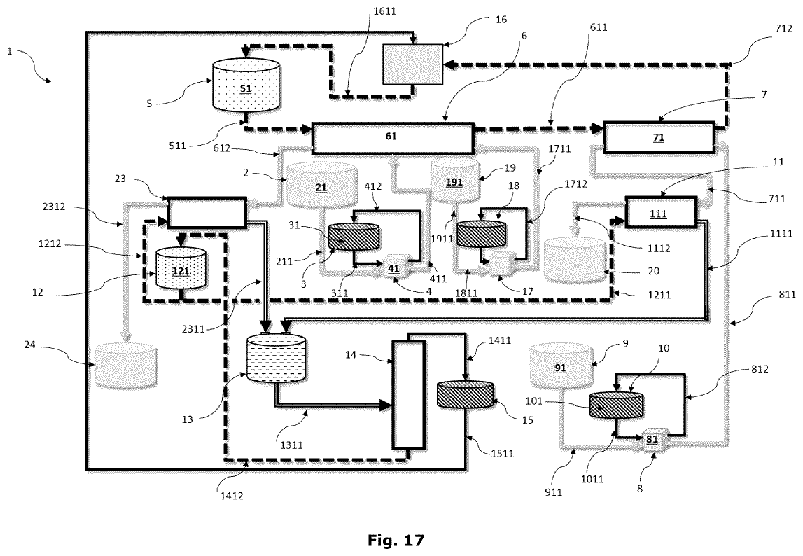

FIG. 16 represents the uranium distribution coefficients (D_{U,eq}) as a function of the concentration of the TOA extractant diluted in different solvents (solid circles: dodecane, solid squares: isooctane, solid triangles peak upwards: toluene and flat triangles peak downwards: PnP).

FIG. 16 shows that the extraction of uranium is much better with PnP with neither the appearance of a 3rd phase nor an increase in the viscosity of the organic phase, whereas with conventional solvents such as dodecane, for example, the 3rd phase appeared from a concentration of 0.1 mol/L onwards. This allows a more compact implementation with smaller amounts of reagents. The extraction process in accordance with the present invention therefore makes it possible to ensure that a third phase accident cannot occur for fundamental reasons, thus avoiding the use of solvent modifiers, but also to increase safety margins against criticality accidents compared with current processes.

### Example 7: Example of an Industrial Facility for Implementing the Extraction Process in Accordance with the Invention

The extraction process in accordance with the present invention and illustrated in examples 1 to 5 above can, for example, be implemented on an industrial extraction facility 1 as represented in FIG. 17 appended hereto.

The facility 1 comprises a tank 2 containing an acidic aqueous phase 21 loaded with metals, a tank 3 containing a non-ionic hydrotropic agent 31, the tanks 2 and 3 respectively feeding via ducts 211 and 311 a container 4 for mixing the acidic aqueous phase 21 loaded with metals with the hydrotropic agent 31 in order to obtain a balanced acidic aqueous phase 41. A duct 412 makes it possible to return the non-ionic hydrotropic agent to the tank 3. Facility 1 also includes a tank 5 containing an organic phase 51 comprising at least one extractant and a non-ionic hydrotropic agent. A battery of extraction stages 6 including several stages (not represented) is supplied in a median stage with a balanced acidic aqueous phase 41 via a duct 411, with an organic phase 51 via a duct 511 at the first stage of the extraction battery and with an aqueous washing solution comprising a non-ionic hydrotropic agent via a duct 1711 leaving a tank 17 at the last stage of the extraction battery. In this way, the aqueous and organic phases circulate in countercurrent in the extraction battery in accordance with standard practice. Each stage of the battery includes a device for mixing the phases and a device for separating these same phases after contact (not represented). Tank 17 is supplied on the one hand with non-ionic hydrotropic agent by means of a duct 1811 coming from a non-ionic hydrotropic agent tank 18 and on the other hand with aqueous washing solution 191 by means of a duct 1911 coming from an aqueous washing solution tank 19. A duct 1712 at the outlet of tank 17 is used to return non-ionic hydrotropic agent to tank 18. After mixing the acidic aqueous phase 21 and the organic phase 51 in the extraction battery 6, at least some of the elements belonging to the rare earths group or the actinides group have been transferred to the organic phase 51. The organic phase 51 thus loaded with metal is then transferred to the first step of a de-extraction battery 7 including several stages (not represented) via a duct 611. The balanced acidic aqueous phase at least partially free from elements belonging to the rare earths group or the actinides group is sent to a de-extraction unit 23 via a duct 612. The de-extraction unit 23 makes it possible to recover the non-ionic hydrotropic agent contained in said acid phase, said non-ionic hydrotropic agent in a mixture with a solvent 121, preferably comprised of a mixture of aliphatic compounds such as Isane. The solvent 121 is sent to tank 13 via a duct 2311. At the outlet of the de-extraction unit 23, the acidic aqueous phase free from the non-ionic hydrotropic agent (raffinate) is transferred via a duct 2312 to a container 24 which can then be emptied.

Facility 1 also comprises a tank 8 containing a de-extraction solution 81 comprising a non-ionic hydrotropic agent. Tank 8 is supplied with an aqueous solution 91 from a tank 9 via a duct 911, as well as with said non-ionic hydrotropic agent 101 from a tank 10 via a duct 1011. A duct 812 is used to return the hydrotropic agent to tank 10 and a duct 811 is used to supply the de-extraction battery 7 with de-extraction solution 81 at the last stage of the battery. On leaving the de-extraction battery 7, the de-extraction solution, which comprises at least part of the elements belonging to the rare earths group or the actinides group 71, is transferred to a de-extraction unit 11 via a duct 711. A tank 12 containing an Isane-type solvent 121 is connected to the tank 11 via a duct 1211. The introduction of solvent 121 into the de-extraction unit 11 makes it possible to recover the non-ionic hydrotropic agent contained in the de-extraction solution 81. The de-extraction solution free from the non-ionic hydrotropic agent but loaded with elements belonging to the rare earths group or the actinides group is sent to a container 20 via a duct 1112. The mixture of solvent 121 and non-ionic hydrotropic agent is transferred via a duct 1111 to a tank 13, itself connected to a distillation unit 14 via a duct 1311. The distillation unit 14 enables the non-ionic hydrotropic agent to be separated from the solvent 121. The non-ionic hydrotropic agent leaving the distillation unit 14 is recovered in a tank 15 via a duct 1411 and then returned to a tank 16 via a duct 1511. The solvent 121 leaving the distillation unit 14 is in turn transferred via a duct 1412 to the tank 12. This tank 12 is further used to supply the de-extraction unit 23 with solvent, which is supplied with solvent 121 via a duct 1212. In addition, at the outlet of the de-extraction unit 7, the organic phase at least partially free from elements belonging to the rare earths group or the actinides group is transferred to the tank 16 via a duct 712. The tank 16 allows the amount of non-ionic hydrotropic agent in the organic phase to be readjusted before it is transferred to the tank 5 via a duct 1611. The elements belonging to the rare earths group or to the actinides group contained in the de-extraction solution present in the container 20 can then be recovered by conventional techniques such as, for example, precipitation of these elements into said solution.

1-20. (canceled)

21. A process for liquid-liquid extraction of at least one salt of a metal selected from elements of the rare earths group and the actinides group from an acidic aqueous phase containing them, said process comprising at least the following steps of:
(i) preparing a balanced acidic aqueous phase (Ph_{aq.e}) comprising said at least one salt of said metal and at least one non-ionic hydrotropic agent in an initial amount Q1,
(ii) preparing an organic phase (Ph_{org}) comprising at least one non-ionic hydrotropic agent in an initial amount Q2 and at least one extractant,
(iii) contacting said organic phase prepared above in step (ii) with said balanced acidic aqueous phase prepared above in step (i), to obtain a mixture M,
(iv) stirring said mixture M, and then
(v) separating said organic phase from said balanced acidic aqueous phase.

22. The process according to claim 21, wherein said metal is selected from lanthanum, neodymium, europium, dysprosium, erbium, ytterbium, uranium, and mixtures thereof.

23. The process according to claim 21, wherein the non-ionic hydrotropic agents used in steps (i) and (ii) are selected from:
alkylene glycol alkyl ethers, the alkyl being selected from methyl, ethyl, n-propyl, isopropyl, n-butyl, isobutyl, terbutyl and pentyl and the alkylene being selected from ethylene and propylene and dipropylene; and
primary alcohols including a C₂-C₃ alkyloxy group.

24. The process according to claim 21, wherein the non-ionic hydrotropic agent is selected from 1-propoxy-2-propanol, dipropylene glycol n-propyl ether and ethylene glycol monopentyl ether.

25. The process according to claim 21, wherein the non-ionic hydrotropic agent present in the balanced acid aqueous phase is identical to the non-ionic hydrotropic agent present in the organic phase.

26. The process according to claim 21, wherein the balanced acidic aqueous phase comprises at least one strong acid in a concentration ranging from 1·10⁻⁴ to 6 mol/L, and preferably from about 0.01 to 4 mol/L.

27. The process according to claim 21, wherein step (i) is a pre-balancing step of adding to an acidic aqueous solution containing at least one salt of a metal selected from elements of the rare earths group and of the actinides group, a pre-balancing phase comprising at least one hydrotropic agent in an initial amount Q1, in order to obtain a balanced acidic aqueous phase.

28. The process according to claim 21, wherein the pre-balancing phase is pure 1-propoxy-2-propanol or pure dipropylene glycol n-propyl ether or pure ethylene glycol monopentyl ether.

29. The process according to claim 27, wherein step (i) is carried out by respecting a pre-balancing phase/acid aqueous phase volume ratio of 1:1 to 1:10.

30. The process according to claim 21, wherein it further comprises, prior to step (i), at least one preliminary leaching step.

31. The process according to claim 21, wherein the extractant present in the organic phase prepared in step (ii) is selected from bis(2-ethylhexyl) phosphoric acid, N,N′-dimethyl-N,N′-dioctylhexyl-ethoxy-malonamide, N,N-di-(2-ethylhexyl) isobutyramide, trioctylamine, and mixtures thereof.

32. The process according to claim 21, wherein the metal to be extracted from the balanced acidic aqueous phase is a lanthanide and the extractant is selected from bis(2-ethylhexyl) phosphoric acid, N,N′-dimethyl-N,N′-dioctylhexyl-ethoxy-malonamide, and mixtures thereof.

33. The process according to claim 32, wherein the extractant is a mixture of bis(2-ethylhexyl) phosphoric acid and N,N′-dimethyl-N,N′-dioctylhexyl-ethoxy-malonamide.

34. The process according to claim 21, wherein the metal to be extracted from the balanced acid aqueous phase is an actinide and the extractant is selected from N,N-di-(2-ethylhexyl) isobutyramide, trioctylamine, and mixtures thereof.

35. The process according to claim 21, wherein the aqueous and organic phases are mixed in a volume proportion equal to 1/1.

36. The process according to claim 21, wherein said process is implemented in an extraction device comprising several stages, each of the stages making it possible to implement steps (iii) to (v), and wherein said process then further comprises, after each step (v) and before each step (iii), at least one intermediate step of readjusting amounts of non-ionic hydrotropic agents present in the acidic aqueous phase and in the organic phase respectively to values identical to the initial values Q1 and Q2.

37. The process according to claim 21, further comprising at least:
a step (vi) of de-extracting salts of the metals present in the organic phase after step (v), said step (vi) comprising at least contacting said organic phase with a so-called “de-extraction solution” aqueous phase, said solution containing at least one non-ionic hydrotropic agent in an initial amount Q3, and then
a step (vii) of separating the organic phase from said de-extraction phase to recover a de-extraction phase comprising salts of said metals.

38. The process according to claim 37, wherein steps (vi) and (vii) are implemented in a multi-stage de-extraction battery, each of the stages making it possible to implement steps (vi) and (vii), and wherein said process then further comprises, after each step (vii) and before each step (vi), at least one intermediate step of readjusting amount of non-ionic hydrotropic agent present in the de-extraction solution to a value identical to the initial value Q3.

39. A process for liquid-liquid extraction of a metal selected from elements of the rare earths group and the actinides group from an acidic aqueous phase containing said metals and a non-ionic hydrotropic agent, comprising contacting an organic phase comprising at least one extractant and a non-ionic hydrotropic agent with an acidic aqueous phase containing said metals and a non-ionic hydrotropic agent.

40. The process according to claim 39, wherein the non-ionic hydrotropic agent of the organic phase is identical to the non-ionic hydrotropic agent of the acidic aqueous phase.
